(19) United States
(12) Patent Application Publication
(10) Pub. No.: US 2026/0259519 A1
(43) Pub. Date: Sep. 3, 2026

(54) IMAGE FORMING APPARATUS

(71) Applicant: BROTHER KOGYO KABUSHIKI KAISHA, Nagoya (JP)

(72) Inventors: Tetsuharu UBE, Nagoya (JP); Sota YANAGIHARA, Seto (JP); Shuya ICHIKAWA, Nagoya (JP); Shuji KAWASAKI, Nagoya (JP); Keita SUZUKI, Nishio (JP)

(73) Assignee: BROTHER KOGYO KABUSHIKI KAISHA, Nagoya (JP)

(21) Appl. No.: 19/549,413

(22) Filed: Feb. 25, 2026

(30) Foreign Application Priority Data
Feb. 28, 2025 (JP) 2025-031686

(51) Int. Cl. G03G 15/08; G03G 15/00; G03G 21/14

(52) U.S. Cl. CPC G03G 15/0848; G03G 15/0813; G03G 15/5004; G03G 15/80; G03G 21/14; G03G 2221/1657

(57) ABSTRACT

An image forming apparatus includes a photosensitive drum, a charger, a developing cartridge including a toner storage and a developing roller, a contact-and‑separation mechanism configured to move the developing roller between a contact position and a separation position, a process motor, a drive transmission mechanism configured to transmit a driving force from the process motor to the developing roller when the developing roller is at the contact position, a high‑voltage power supply board configured to apply, to the charger, a voltage for charging the photosensitive drum, a controller. The controller is configured to execute a toner solidification determination process of applying the voltage to the charger and determining whether toner solidification has occurred in the toner storage based on a rotation of the process motor in a state where the developing roller has been moved from the separation position to the contact position.

### REFERENCE TO RELATED APPLICATIONS

This application claims priority under 35 U.S.C. §119 from Japanese Patent Application No. 2025-031686 filed on February 28, 2025. The entire subject matter of the application is incorporated herein by reference.

### BACKGROUND ART

The present invention relates to an image forming apparatus that determines whether toner has been solidified.

Conventionally, an image forming apparatus includes a developing cartridge having a developer accommodating portion that accommodates toner and a developing roller configured to supply the toner to a photosensitive drum. If the developing cartridge has been left under a high-temperature condition, toner may become solidified inside the developing cartridge.

For example, it is known that a motor that drives a toner stirring member is provided, a state of toner is estimated by comparing a rotational speed of the motor with an initially set target speed, and toner solidification is determined based on the estimation result.

In this technique, the toner solidification is determined based on the rotational speed of the motor configured to rotate a member which comes into contact with toner. On the other hand, an image forming apparatus has been proposed which includes a mechanism that brings the developing roller into contact with a photosensitive drum. When the developing roller is in a state of being in contact with the photosensitive drum, a driving force from a motor is transmitted to the developing roller in such a manner that the developing roller rotates. In such an image forming apparatus, it is conceivable to determine the toner solidification by using the developing roller as the member that contacts the toner and based on the speed of the motor that rotates the developing roller.

However, in such an image forming apparatus, the developing roller does not rotate unless the developing roller is in a state of being in contact with the photosensitive drum. Therefore, when the developing roller is rotated in order to detect a state of the toner inside the developing cartridge, the toner moves from the developing roller to the photosensitive drum, and the toner inside the developing cartridge is wastefully consumed.

### SUMMARY

According to aspects of the present disclosure, an image forming apparatus includes a photosensitive drum, a charger configured to charge the photosensitive drum, a developing cartridge including a toner storage configured to accommodate toner, and a developing roller configured to supply the toner to the photosensitive drum, a contact‑and‑separate mechanism configured to move the developing roller between a contact position and a separation position, the contact position being a position where the developing roller is in contact with the photosensitive drum, the separation position being a position where the developing roller is separated from the photosensitive drum, a process motor configured to rotate the photosensitive drum and the developing roller, a drive transmission mechanism configured to transmit a driving force from the process motor to the developing roller when the developing roller is at the contact position, and not to transmit the driving force from the process motor to the developing roller when the developing roller is at the separation position, a high‑voltage power supply board configured to apply, to the charger, a voltage for charging the photosensitive drum, and a controller. The controller is configured to execute a toner solidification determination process of applying the voltage to the charger by using the high‑voltage power supply board while rotating the photosensitive drum by using the process motor in a state where the developing roller is at the separation position, and thereafter, determining whether toner solidification has occurred in the toner storage based on a rotation of the process motor in a state where the developing roller has been moved from the separation position to the contact position by using the contact‑and‑separate mechanism.

### BRIEF DESCRIPTION OF THE DRAWINGS

FIG. 1 is a schematic configuration diagram of an image forming apparatus.

FIG. 2 is a block diagram illustrating a configuration of the image forming apparatus.

FIG. 3 is a schematic configuration diagram of a drive transmission mechanism.

FIG. 4 is a schematic configuration diagram of a process motor.

FIG. 5 is a diagram illustrating a high-voltage power supply board used when performing a toner solidification determination process.

FIGS. 6A-6C are diagrams illustrating a relationship between charging and movement of toner.

FIG. 7 is a flowchart of a toner solidification determination process.

FIG. 8 is a flowchart of a motor failure determination process.

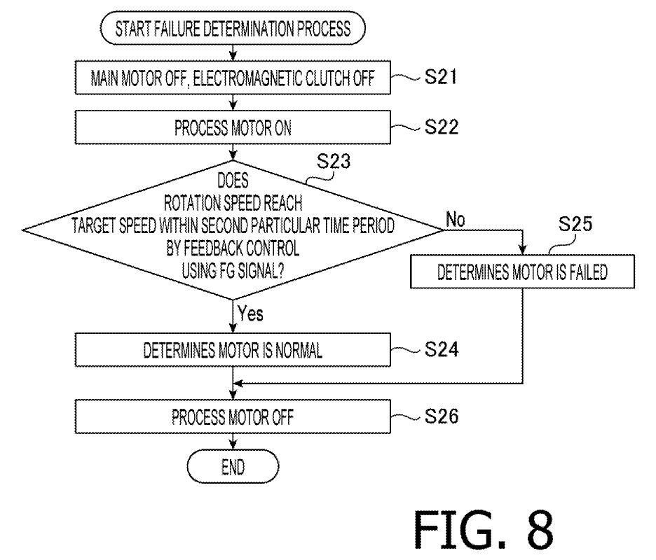

FIG. 9 is a flowchart of a process performed upon developing cartridge replacement.

FIG. 10 is a flowchart in a mode for determining a color in which toner has solidified.

FIG. 11 is a flowchart in a mode for determining whether monochrome printing is possible.

### DESCRIPTION

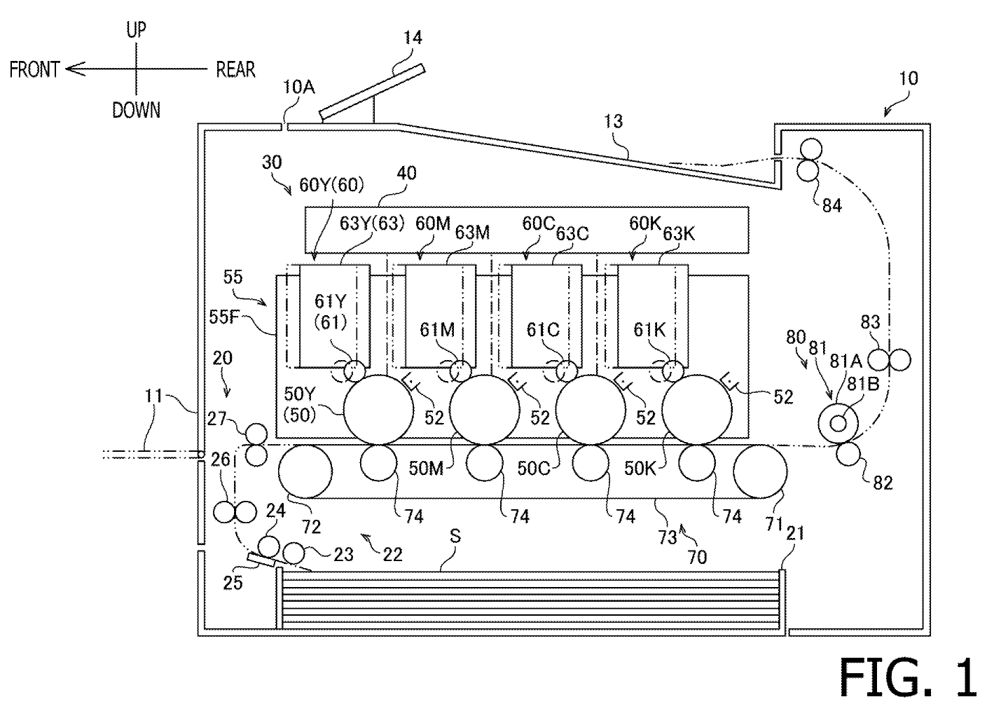

Hereinafter, an embodiment of an image forming apparatus according to aspects of the present disclosure will be described in detail with reference to the drawings. First, FIG. 1 is a schematic configuration diagram of the image forming apparatus according to this embodiment.

As shown in FIG. 1, the image forming apparatus 1 is a color printer and includes a housing 10, a display 14, a front cover 11, a sheet feeder 20, an image forming unit 30, and a second discharge roller 84 serving as a discharge roller. In the present embodiment, a left side of FIG. 1 is defined as a front side, and a right side of FIG. 1 is defined as a rear side. An upper side of FIG. 1 is defined as an upper side, and a lower side of FIG. 1 is defined as a lower side. A side of a plane of FIG. 1 that is nearer to a viewer is defined as a right side, and a side of the plane of FIG. 1 that is farther from the viewer is defined as a left side.

The housing 10 has an opening 10A at a front portion. The front cover 11 opens and closes the opening 10A. Specifically, the front cover 11 is pivotable with respect to the housing 10 between a closed position indicated by a solid line and an open position indicated by a dashed line. The closed position is a position in which the opening 10A is closed, and the open position is a position in which the opening 10A is open.

The display 14 is a liquid crystal display and is attached to the housing 10. The display 14 displays various kinds of information for a user based on an image signal obtained from an ASIC 92.

The sheet feeder 20 includes a sheet tray 21 and a sheet feeding mechanism 22. A sheet S is set on the sheet tray 21. The sheet feeding mechanism 22 is a mechanism that, upon receiving a driving force, supplies the sheet S toward photosensitive drums 50 (50Y, 50M, 50C, 50K), which will be described later, of the image forming unit 30. The sheet feeding mechanism 22 includes a pickup roller 23, a separation roller 24, a separation pad 25, a conveying roller 26, and a registration roller 27.

The sheet feeding mechanism 22 feeds the sheet S from the sheet tray 21 by the pickup roller 23. Next, the sheet feeding mechanism 22 separates the sheet S into a single sheet between a separation roller 24 and a separation pad 25. Thereafter, the sheet feeding mechanism 22 supplies the sheet S toward the image forming unit 30 by the conveying roller 26 and the registration roller 27.

The image forming unit 30 includes an exposure unit 40, four photosensitive drums 50, four developing cartridges 60, a transfer unit 70, and a fixing device 80. The exposure unit 40 includes, for example, a light source, a deflector, a lens, and a mirror. The exposure unit 40 emits a light beam indicated by one-dot chain lines in FIG. 1 to expose a surface of the photosensitive drum 50.

The photosensitive drum 50 includes a photosensitive drum 50Y corresponding to yellow, a photosensitive drum 50M corresponding to magenta, a photosensitive drum 50C corresponding to cyan, and a photosensitive drum 50K corresponding to black. The four photosensitive drums 50 are arranged, from upstream toward downstream in a conveying direction of the sheet S, in the order of the photosensitive drum 50Y, the photosensitive drum 50M, the photosensitive drum 50C, and the photosensitive drum 50K.

Specifically, the photosensitive drum 50Y is arranged upstream of the photosensitive drum 50M in the conveying direction of the sheet S. The photosensitive drum 50M is arranged upstream of the photosensitive drum 50C in the conveying direction of the sheet S. The photosensitive drum 50C is arranged upstream of the photosensitive drum 50K in the conveying direction of the sheet S.

In the present specification and the drawings, for members corresponding to respective colors, when colors are distinguished, reference numerals are suffixed with Y, M, C, and K, and when colors are not distinguished, the reference numerals are not suffixed with Y, M, C, and K.

The image forming apparatus 1 further includes a drawer 55. The drawer 55 is movable, through the opening 10A of the housing 10 that is exposed by opening the front cover 11, in a direction in which the photosensitive drums 50 are arranged, between an inner position and an outer position. The inner position is a position at which the drawer 55 is accommodated inside the housing 10, and the outer position is a position at which at least a part of the drawer 55 is exposed to the outside of the housing 10. In this embodiment, the outer position is a position where the drawer 55 is pulled forward from the inner position. Further, in this embodiment, the drawer 55 is attachable to and detachable from the housing 10.

The drawer 55 includes a frame 55F. The frame 55F rotatably supports four photosensitive drums 50 (50Y, 50M, 50C, 50K). The frame 55F also supports four chargers 52. Each charger 52 charges a surface of a corresponding photosensitive drum 50.

The developing cartridges 60 have a toner storage 63 that accommodates toner, and the developing cartridges 60 include a developing cartridge 60Y having a toner storage 63Y that accommodates yellow toner, a developing cartridge 60M having a toner storage 63M that accommodates magenta toner, a developing cartridge 60C having a toner storage 63C that accommodates cyan toner, and a developing cartridge 60K having a toner storage 63K that accommodates black toner. The developing cartridge 60Y has a developing roller 61Y configured to supply yellow toner to the photosensitive drum 50Y. The developing cartridge 60M has a developing roller 61M configured to supply magenta toner to the photosensitive drum 50M. The developing cartridge 60C has a developing roller 61C configured to supply cyan toner to the photosensitive drum 50C. The developing cartridge 60K has a developing roller 61K configured to supply black toner to the photosensitive drum 50K.

The developing roller 61Y is movable with respect to the photosensitive drum 50Y between a contact position in which the developing roller 61Y is in contact with the photosensitive drum 50Y and a separation position in which the developing roller 61Y is separated from the photosensitive drum 50Y. The developing roller 61M is movable with respect to the photosensitive drum 50M between a contact position in which the developing roller 61M is in contact with the photosensitive drum 50M and a separation position in which the developing roller 61M is separated from the photosensitive drum 50M. The developing roller 61C is movable with respect to the photosensitive drum 50C between a contact position in which the developing roller 61C is in contact with the photosensitive drum 50C and a separation position in which the developing roller 61C is separated from the photosensitive drum 50C. The developing roller 61K is movable with respect to the photosensitive drum 50K between a contact position in which the developing roller 61K is in contact with the photosensitive drum 50K and a separation position in which the developing roller 61K is separated from the photosensitive drum 50K.

The frame 55F of the drawer 55 removably supports the developing cartridges 60 (60Y, 60M, 60C, 60K). Each developing cartridge 60 can be replaced in a state where the drawer 55 is at the outer position or in a state where the drawer 55 has been removed from the housing 10.

Each developing cartridge 60 is supported by the frame 55F so as to be movable in the front-rear direction between a first position indicated by a solid line and a second position indicated by a dashed line. The first position is a position in which the corresponding developing roller 61 is located at the contact position, and the second position is a position in which the corresponding developing roller 61 is located at the separation position.

Specifically, the developing cartridge 60Y is movable with respect to the photosensitive drum 50Y between the first position in which the developing roller 61Y is located at the contact position and the second position in which the developing roller 61Y is located at the separation position. In other words, the developing cartridge 60Y is movable with respect to the photosensitive drum 50Y between the first position in which the developing roller 61Y is in contact with the photosensitive drum 50Y and the second position in which the developing roller 61Y is separated from the photosensitive drum 50Y.

Further, the developing cartridge 60M is movable with respect to the photosensitive drum 50M between the first position in which the developing roller 61M is located at the contact position and the second position in which the developing roller 61M is located at the separation position. In other words, the developing cartridge 60M is movable with respect to the photosensitive drum 50M between the first position in which the developing roller 61M is in contact with the photosensitive drum 50M and the second position in which the developing roller 61M is separated from the photosensitive drum 50M.

Further, the developing cartridge 60C is movable with respect to the photosensitive drum 50C between the first position in which the developing roller 61C is located at the contact position and the second position in which the developing roller 61C is located at the separation position. In other words, the developing cartridge 60C is movable with respect to the photosensitive drum 50C between the first position in which the developing roller 61C is in contact with the photosensitive drum 50C and the second position in which the developing roller 61C is separated from the photosensitive drum 50C.

Further, the developing cartridge 60K is movable with respect to the photosensitive drum 50K between the first position in which the developing roller 61K is located at the contact position and the second position in which the developing roller 61K is located at the separation position. In other words, the developing cartridge 60K is movable with respect to the photosensitive drum 50K between the first position in which the developing roller 61K is in contact with the photosensitive drum 50K and the second position in which the developing roller 61K is separated from the photosensitive drum 50K.

Further, each developing cartridge 60 is provided with a toner IC 62. The toner IC 62 is a non-volatile storage in which data can be rewritten, and toner solidification information, identification information, and the like of the developing cartridge 60 are stored. The toner IC 62 is an example of the storage.

The transfer unit 70 includes a driving roller 71, a driven roller 72, an endless conveying belt 73, and four transfer rollers 74. The conveying belt 73 is stretched between the driving roller 71 and the driven roller 72 such that an outer surface thereof is in contact with the four photosensitive drums 50. The transfer rollers 74 are arranged inside the conveying belt 73 so as to sandwich the conveying belt 73 between the transfer rollers 74 and corresponding photosensitive drums 50.

The fixing device 80 is an example of a fixing device and is a device that thermally fixes a toner image transferred onto the sheet S. The fixing device 80 has a heating portion 81, a pressing portion 82, and a first discharge roller 83 serving as a discharge roller. The heating portion 81 is an example of a heating rotor and includes a heating roller 81A and a heater 81B. The heating roller 81A is a cylindrical roller made of metal. The heater 81B is configured to heat the heating roller 81A and is arranged so as to pass through an inside of the heating roller 81A.

The pressing portion 82 is an example of a pressing rotor and presses the sheet S between the pressing portion 82 and the heating portion 81. Specifically, the pressing portion 82 is a pressing roller that holds the sheet S between the pressing roller and the heating roller 81A. The pressing roller is a roller in which a core metal is covered with a rubber layer. When receiving a driving force, the fixing device 80 conveys the sheet S between the heating roller 81A of the heating portion 81 and the pressing portion 82 (i.e., the pressing roller). The fixing device 80 also conveys the sheet S by the first discharge roller 83 when receiving the driving force.

The pressing portion 82 (pressing rotor) is configured to rotate, for example, by being driven via contact with the heating roller 81A when the main motor M1 rotates the heating roller 81A.

The image forming unit 30, after uniformly charging a surface of the photosensitive drum 50 by the charger 52, exposes the surface with a light beam emitted from the exposure unit 40. As a result, the image forming unit 30 forms an electrostatic latent image based on image data on the photosensitive drum 50. The image forming unit 30 also supplies toner accommodated in the developing cartridge 60 to the photosensitive drum 50 from the developing roller 61 that is located at the contact position. Thus, the image forming unit 30 forms a toner image on the photosensitive drum 50.

The image forming unit 30 transfers the toner image formed on the photosensitive drum 50 onto the sheet S by conveying the sheet S supplied from the sheet feeder 20 between the photosensitive drum 50 and the transfer roller 74. Thereafter, the image forming unit 30 fixes the toner image on the sheet S by conveying the sheet S onto which the toner image has been transferred between the heating roller 81A and the pressing portion 82.

The first discharge roller 83 and the second discharge roller 84, when receiving a driving force, discharge the sheet S from between the heating portion 81 and the pressing portion 82 to outside the housing 10. Specifically, the first discharge roller 83 and the second discharge roller 84 discharge the sheet S on which the toner image has been fixed to the discharge tray 13.

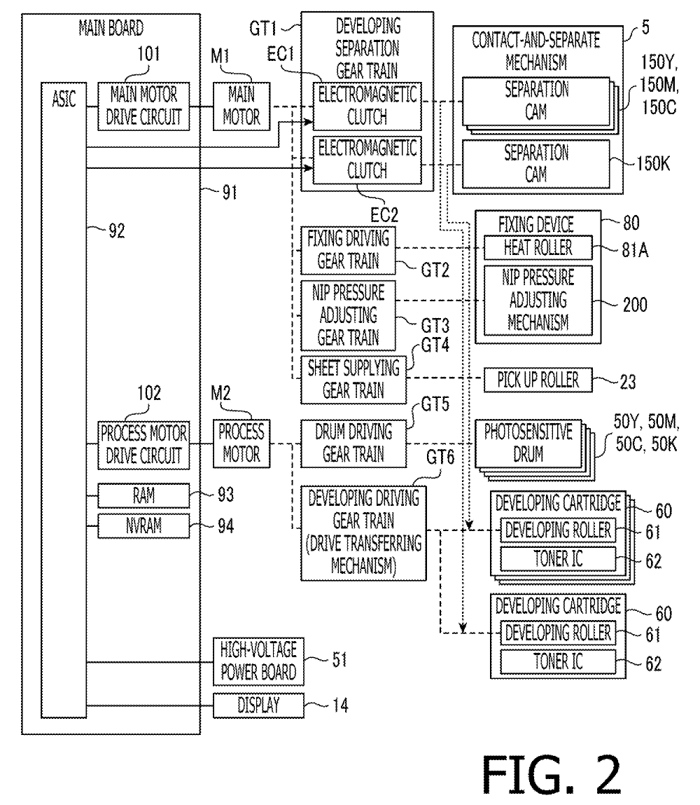

FIG. 2 is a block diagram illustrating a configuration of the image forming apparatus according to the present embodiment. A main board 91 is connected to a main motor M1, a process motor M2, a high-voltage power supply board 51, and the display 14.

First, the main board 91 is a control board that controls an entire image forming apparatus and includes an ASIC 92, a RAM 93 that is used as a working memory when the ASIC 92 performs various arithmetic processes, an NVRAM 94 in which control programs and the like are stored, a main motor driving circuit 101, and a process motor driving circuit 102. The ASIC 92 is an example of the controller.

The main motor driving circuit 101 is connected to the ASIC 92 and the main motor M1. The main motor driving circuit 101 controls a rotational speed and a rotational direction of the main motor M1 based on an instruction from the ASIC 92.

The process motor driving circuit 102 is connected to the ASIC 92 and the process motor M2. The process motor driving circuit 102 controls a rotational speed and a rotational direction of the process motor M2 based on an instruction from the ASIC 92. Details thereof will be described later.

The high-voltage power supply board 51 applies to the charger 52 a voltage for charging the photosensitive drum 50. The high-voltage power supply board 51 can also apply a voltage to the developing roller 61.

The main motor M1 is connected so as to transmit a driving force to a developing separation gear train GT1, a fixing driving gear train GT2, a nip pressure adjusting gear train GT3, and a sheet supplying gear train GT4. The main motor M1 is a motor that, via the respective gear trains, drives separation cams of a contact-and-separate mechanism 5, the fixing device 80, a nip pressure adjusting mechanism 200, and a sheet feeding mechanism 22. The main motor M1 is capable of rotating in forward and reverse directions, and rotates in a forward direction when the sheet S is conveyed from the sheet tray 21 toward the discharge tray 13 in order to form an image on the sheet S.

The process motor M2 is connected so as to transmit a driving force to a drum driving gear train GT5 and a developing driving gear train GT6. The process motor M2 is a motor that, via the respective gear trains, drives the photosensitive drums 50, the developing rollers 61, and the transfer unit 70.

The developing separation gear train GT1 is a gear train that transmits a driving force of the main motor M1 to a separation cam 150 of the contact-and-separate mechanism 5. The developing separation gear train GT1 also includes an electromagnetic clutch EC1 and an electromagnetic clutch EC2. The electromagnetic clutch EC1 is configured to be located between the main motor M1 and separation cams 150Y, 150M, and 150C. The electromagnetic clutch EC2 is configured to be located between the main motor M1 and a separation cam 150K.

The fixing driving gear train GT2 is a gear train that receives a driving force of the main motor M1 via the developing separation gear train GT1 and transmits the driving force to the fixing device 80. Specifically, the fixing driving gear train GT2 receives the driving force of the main motor M1 from the developing separation gear train GT1 and transmits the driving force to the heating roller 81A.

The nip pressure adjusting gear train GT3 is a gear train that receives a driving force of the main motor M1 from the developing separation gear train GT1 and transmits the driving force to the nip pressure adjusting mechanism 200. The sheet supplying gear train GT4 is a gear train that transmits a driving force of the main motor M1 to the sheet feeding mechanism 22. The drum driving gear train GT5 is a gear train that transmits the driving force of the process motor M2 to the photosensitive drums 50 and the driving roller 71.

The developing driving gear train GT6 is a drive transmission mechanism that transmits a driving force of the process motor M2 to the developing rollers 61. Details thereof will be described later.

The electromagnetic clutch EC1 is switchable between a transmission state and a cutoff state. In one example, the electromagnetic clutch EC1 is brought into the transmission state when energized and is brought into the cutoff state when not energized. The transmission state is a state in which the driving force from the main motor M1 is transmitted to the separation cams 150Y, 150M, and 150C. The cutoff state is a state in which the driving force from the main motor M1 is not transmitted to the separation cams 150Y, 150M, and 150C. The electromagnetic clutch EC1 is controlled by the ASIC 92.

The electromagnetic clutch EC2 is switchable between a transmission state and a cutoff state. In one example, the electromagnetic clutch EC2 is brought into the transmission state when energized and is brought into the cutoff state when not energized. The transmission state is a state in which a driving force from the main motor M1 is transmitted to the separation cam 150K. The cutoff state is a state in which the driving force from the main motor M1 is not transmitted to the separation cam 150K. The electromagnetic clutch EC2 is controlled by the ASIC 92.

The contact-and-separate mechanism 5 is a mechanism that moves the developing roller 61 between a contact position and a separation position by receiving a driving force from the main motor M1. The contact-and-separate mechanism 5 includes four separation cams 150 and a structure that moves the developing roller 61 by rotation of the separation cams 150. The separation cams 150 include the separation cam 150Y, the separation cam 150M, the separation cam 150C, and the separation cam 150K.

The separation cam 150Y rotates by receiving the driving force from the main motor M1 and moves the developing roller 61Y between the contact position and the separation position. Specifically, the separation cam 150Y moves the developing cartridge 60Y between the first position and the second position by its rotation, thereby moving the developing roller 61Y between the contact position and the separation position.

The separation cam 150M rotates by receiving the driving force from the main motor M1 and moves the developing roller 61M between the contact position and the separation position. Specifically, the separation cam 150M moves the developing cartridge 60M between the first position and the second position by its rotation, thereby moving the developing roller 61M between the contact position and the separation position.

The separation cam 150C rotates by receiving the driving force from the main motor M1 and moves the developing roller 61C between the contact position and the separation position. Specifically, the separation cam 150C moves the developing cartridge 60C between the first position and the second position by its rotation, thereby moving the developing roller 61C between the contact position and the separation position.

The separation cam 150K rotates by receiving the driving force from the main motor M1 and moves the developing roller 61K between the contact position and the separation position. Specifically, the separation cam 150K moves the developing cartridge 60K between the first position and the second position by its rotation, thereby moving the developing roller 61K between the contact position and the separation position.

The nip pressure adjusting mechanism 200 switches a nip pressure between a first nip pressure and a second nip pressure, the nip pressure being applied by a heating portion 81 and a pressing portion 82 of the fixing device 80.

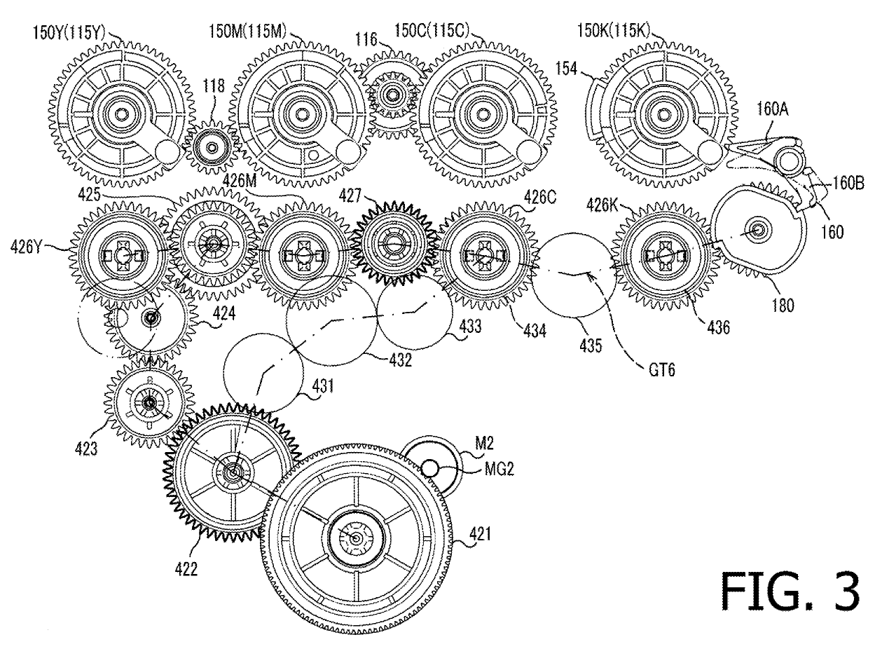

FIG. 3 is a diagram illustrating the separation cam 150 and a part of gear trains of the developing driving gear train GT6 serving as a drive transmission mechanism. FIG. 3 illustrates gear trains when viewed in a direction from the right side to the left side of the image forming apparatus 1. The separation cam 150Y including a cam gear 115Y, the separation cam 150M including a cam gear 115M, the separation cam 150C including a cam gear 115C, the separation cam 150K including a cam gear 115K, an idler gear 118, and a gear 116 constitute a part of the developing separation gear train GT1.

The separation cam 150C (i.e., the cam gear 115C) meshes with the separation cam 150M (i.e., the cam gear 115M) via the gear 116, and the separation cam 150M (i.e., cam gear 115M) meshes with the separation cam 150Y (i.e., the cam gear 115Y) via the idler gear 118. Further, the separation cam 150C (i.e., the cam gear 115C) can transmit a driving force of the main motor M1 to the developing cartridge 60Y, the developing cartridge 60M, and the developing cartridge 60C via the electromagnetic clutch EC1. Accordingly, when the electromagnetic clutch EC1 is in the transmission state, the separation cam 150Y (i.e., the cam gear 115Y), the separation cam 150M (i.e., the cam gear 115M), and the separation cam 150C (i.e., the cam gear 115C) operate in association with one another to move the developing cartridges 60Y, 60M, and 60C between the contact position and the separation position. When the main motor M1 rotates in a forward direction, the developing cartridges 60Y, 60M, and 60C move from the separation position to the contact position, and when the main motor M1 rotates in a reverse direction, the developing cartridges 60Y, 60M, and 60C move from the contact position to the separation position. In addition, when the electromagnetic clutch EC1 is in the cutoff state, either the contact position or the separation position is maintained.

The separation cam 150K (cam gear 115K) can transmit a driving force of the main motor M1 to the developing cartridge 60K via the electromagnetic clutch EC2. Accordingly, when the electromagnetic clutch EC2 is in the transmission state, the separation cam 150K (i.e., the cam gear 115K) moves the developing cartridge 60K between the contact position and the separation position. When the main motor M1 rotates in the forward direction, the developing cartridge 60K moves from the separation position to the contact position, and when the main motor M1 rotates in the reverse direction, the developing cartridge 60K moves from the contact position to the separation position. Moreover, when the electromagnetic clutch EC2 is in the cutoff state, either the contact position or the separation position is maintained.

According to the developing separation gear train GT1 described above, a driving force of the main motor M1 can be controlled to be in the transmission state or in the cutoff state by the electromagnetic clutches EC1 and EC2, and, in the transmission state, the contact-and-separate mechanism 5 can move the developing rollers 61 (i.e., 61Y, 61M, 61C, 61K) to the contact position in which the developing rollers 61 are in contact with the photosensitive drums 50 (i.e., 50Y, 50M, 50C, 50K) or to the separation position in which the developing rollers 61 are separated from the photosensitive drums 50. Further, by bringing only the electromagnetic clutch EC1 into the cutoff state, only the developing roller 61K can be moved to the contact position in which the developing roller 61K is in contact with the photosensitive drum 50K or to the separation position in which the developing roller 61K is separated from the photosensitive drum 50K.

The developing driving gear train GT6 includes a gear 421, a gear 422, a gear 423, a movable gear 424, a first output gear 425, a coupling gear 426Y, a coupling gear 426M, a gear 427, a coupling gear 426C, a gear 431, a gear 432, a gear 433, a gear 434, a gear 435, a first gear 436, a planetary gear mechanism 180, a coupling gear 426K serving as a second gear, and a switching cam.

The gear 421 is a two-stage gear having a large diameter gear and a small diameter gear, and the large diameter gear meshes with a motor gear MG2. The motor gear MG2 is located, in a front-rear direction, between a rotational center of the coupling gear 426M and a rotational center of the coupling gear 426C. The gear 422 meshes with the small diameter gear of the gear 421. The gear 423 meshes with the gear 422.

The movable gear 424 is a gear that receives a driving force from the process motor M2 and meshes with the gear 423. The movable gear 424 is movable with respect to the first output gear 425 between a first transmission position indicated by a solid line and a first disengaged position indicated by a dashed line. Specifically, the movable gear 424 is swingably supported about the gear 423 between the first transmission position and the first disengaged position.

The first transmission position is a position in which the movable gear 424 meshes with the first output gear 425 and outputs the driving force of the process motor M2 toward the developing rollers 61Y, 61M, and 61C. The first disengaged position is a position in which the movable gear 424 does not mesh with the first output gear 425 and does not output the driving force of the process motor M2 toward the developing rollers 61Y, 61M, and 61C. The movable gear 424 is biased by a spring from the first disengaged position toward the first transmission position. The movable gear 424 moves between the first transmission position and the first disengaged position by a switching cam (not shown).

The first output gear 425 is a gear that outputs a driving force toward the developing rollers 61Y, 61M, and 61C. The first output gear 425 is a two-stage gear having a large diameter gear and a small diameter gear, and the large diameter gear meshes with the movable gear 424 that is located at the first transmission position.

The coupling gear 426Y meshes with the small diameter gear of the first output gear 425. The coupling gear 426Y is a gear that outputs the driving force from the process motor M2 toward the developing roller 61Y. Specifically, the coupling gear 426Y outputs the driving force from the process motor M2 to the developing cartridge 60Y.

The coupling gear 426M meshes with the small diameter gear of the first output gear 425. The coupling gear 426M is a gear that outputs the driving force from the process motor M2 toward the developing roller 61M. Specifically, the coupling gear 426M outputs the driving force from the process motor M2 to the developing cartridge 60M. The gear 427 meshes with the coupling gear 426M.

The coupling gear 426C meshes with the gear 427. The coupling gear 426C is a gear that outputs the driving force from the process motor M2 toward the developing roller 61C. Specifically, the coupling gear 426C outputs the driving force from the process motor M2 to the developing cartridge 60C.

Further, the gear 431 meshes with the gear 422. The gear 432 meshes with the gear 431. The gear 433 meshes with the gear 432. The gear 434 meshes with the gear 433. The gear 434 rotates coaxially with the coupling gear 426C. The gear 435 meshes with the gear 434.

The first gear 436 is a gear that receives a driving force from the process motor M2 and meshes with the gear 435. The first gear 436 meshes with the planetary gear mechanism 180. The first gear 436 rotates coaxially with the coupling gear 426K.

The planetary gear mechanism 180 meshes with the coupling gear 426K, and, in a state where rotation of an internal gear is stopped, outputs the driving force of the process motor M2 from the first gear 436 toward the developing roller 61K. On the other hand, in a state where rotation of the internal gear is not stopped, the driving force of the process motor M2 transmitted from the first gear 436 does not rotate the coupling gear 426K and is not output toward the developing roller 61K.

The separation cam 150K including the cam gear 115K, which corresponds to a black color, includes a projection 154 that protrudes from an outer peripheral surface. The projection 154 can come into contact with a switching lever 160. The projection 154, in accordance with rotation of the separation cam 150K, contacts an arm 160A of the switching lever 160 so as to rotate the switching lever 160. Further, the switching lever 160 includes, in addition to the arm 160A that contacts the projection 154, an arm 160B that contacts the internal gear of the planetary gear mechanism 180. When the arm 160B contacts the internal gear of the planetary gear mechanism 180, rotation of the internal gear is prevented. On the other hand, when the arm 160B does not contact the internal gear of the planetary gear mechanism 180, rotation of the internal gear is allowed.

Further, the separation cam 150K including the cam gear 115K, in order to move the developing cartridge 60K from the contact position to the separation position, comes into contact with the arm 160A of the switching lever 160 by the projection 154 when the separation cam 150K rotates by receiving a rotational force from the main motor M1. That is, in conjunction with the contact-and-separate mechanism 5 moving the developing cartridge 60K from the contact position to the separation position by a driving force of the main motor M1, the switching lever 160 is kept out of contact with the internal gear of the planetary gear mechanism 180, so that a driving force of the process motor M2 does not rotate the coupling gear 426K and no driving force is output toward the developing roller 61K.

A not-shown switching cam is a plate cam that rotates by receiving a driving force from the main motor M1. A structure that uses the switching cam to cause a gear to transition between a contact state and a non-contact state is known, and therefore detailed description thereof is omitted. The switching cam rotates by receiving the driving force of the main motor M1 from the cam gear 115M, and moves the movable gear 424 of the developing driving gear train GT6 with respect to the first output gear 425 between a first transmission position indicated by a solid line and a first cutoff position indicated by a dashed line shown in FIG. 3. When the main motor M1 rotates in a forward direction, the switching cam moves the movable gear 424 from the first cutoff position to the first transmission position. When the main motor M1 rotates in a reverse direction, the switching cam moves the movable gear 424 from the first transmission position to the first cutoff position.

According to the developing driving gear train GT6 serving as the drive transmission mechanism described above, when the developing rollers 61 (i.e., 61Y, 61M, 61C, 61K) are at the separation position with respect to the photosensitive drums 50 (i.e., 50Y, 50M, 50C, 50K) by the developing separation gear train GT1, a driving force from the process motor M2 is not transmitted to the developing rollers 61 (i.e., 61Y, 61M, 61C, 61K). On the other hand, when the developing rollers 61 are at the contact position, the driving force from the process motor M2 is transmitted to the developing rollers 61 (i.e., 61Y, 61M, 61C, 61K). Further, by bringing only the electromagnetic clutch EC1 into the cutoff state, when only the developing roller 61K is brought into the contact position with the photosensitive drum 50K, the driving force from the process motor M2 is transmitted only to the developing roller 61K.

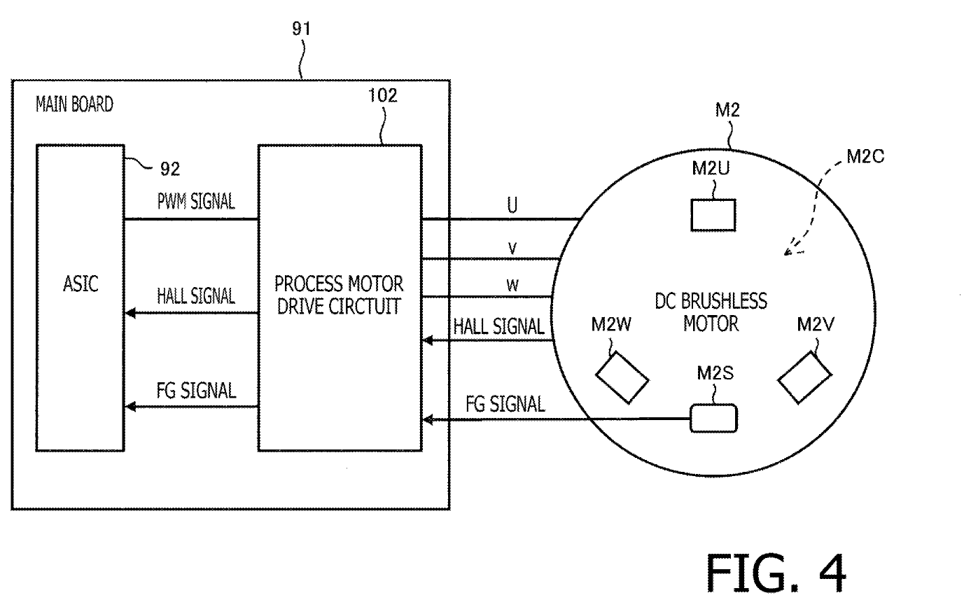

As shown in FIG. 4, the process motor M2 is a three-phase brushless motor, and a stator has three phase (U, V, W) drive coils M2C and Hall elements M2U, M2V, and M2W and an FG sensor M2S for detecting a rotational position of a rotor.

The FG sensor M2S is configured such that an induced electromotive force is generated in the FG sensor M2S in accordance with rotation of the rotor of the brushless motor. The FG sensor M2S outputs an AC signal (i.e., FG signal) whose frequency corresponds to a rotational speed of the rotor. When the rotational speed of the brushless motor is high, a frequency of the FG signal becomes high, and when the rotational speed is low, the frequency becomes low.

The ASIC 92 detects a rotational speed of the three-phase brushless motor based on the FG signal that is input via the process motor driving circuit 102. The ASIC 92 executes feedback control based on the FG signal output from the FG sensor M2S, changes, by the feedback control, a PWM signal, which is a control signal indicating a pulse width (duty ratio), and outputs the PWM signal to the motor driving circuit. The process motor driving circuit 102 controls an amount of current supplied to the three-phase drive coils M2C in accordance with the duty ratio of the input PWM signal, and, based on Hall signals input from the Hall elements M2U, M2V, and M2W, switches timing of supplying current to the three-phase drive coils M2C so as to switch a direction of a magnetic field generated by the three-phase drive coils M2C and thereby rotate the rotor.

Further, the main motor M1 is also a three-phase brushless motor and has a similar configuration, and rotation of the main motor M1 is controlled by the ASIC 92. A motor driving circuit used for this purpose is the main motor driving circuit 101, as shown in FIG. 2.

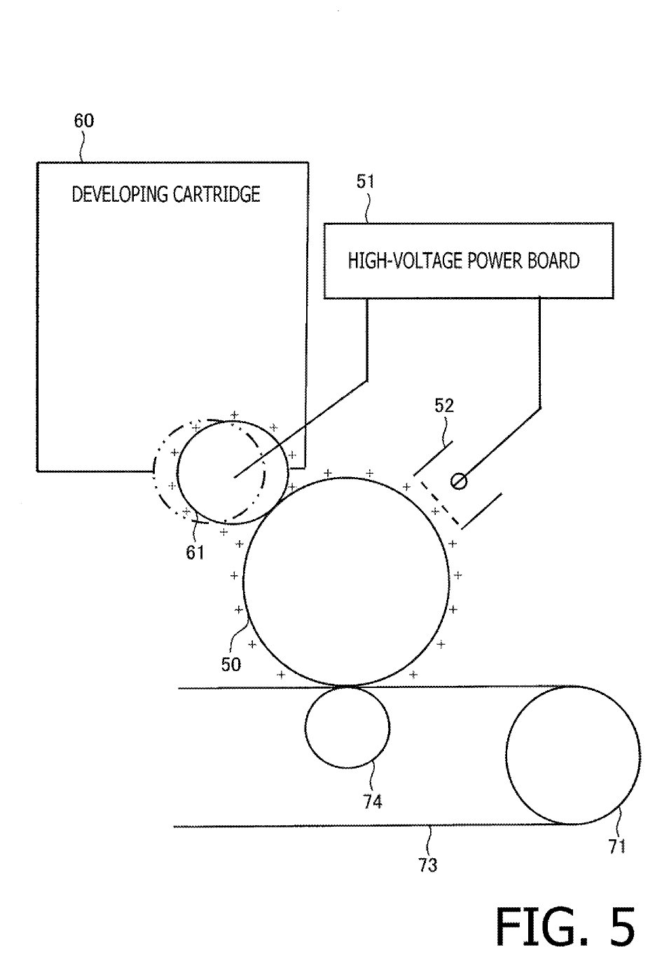

In the image forming apparatus 1 having the above configuration, charging of respective parts when a toner solidification determination process is performed will be described with reference to FIG. 5. A high-voltage power supply board 51 is configured so as to be able to apply voltages to the charger 52 and the developing roller 61. The high-voltage power supply board 51 can apply a voltage to the developing roller 61 both when the developing roller 61 is at the separation position and when the developing roller 61 is at the contact position.

At the separation position, the high-voltage power supply board 51 applies a first positive voltage to the charger 52. Further, the ASIC 92 rotates the process motor M2 so as to rotate the photosensitive drum 50 and the driving roller 71 via the drum driving gear train GT5. The charger 52 positively charges a surface of the photosensitive drum 50 based on the first positive voltage applied from the high-voltage power supply board 51. As the photosensitive drum 50 rotates, an entire surface of the photosensitive drum 50 is uniformly positively charged. Here, the toner accommodated in the developing cartridge 60 is positively charged toner that is charged with a positive polarity, and a potential of the surface of the photosensitive drum 50 is made higher than a potential of the developing roller 61.

Here, when the photosensitive drum 50 is charged, the photosensitive drum 50 is rotated by at least one full revolution. The ASIC 92 moves the developing roller 61 from the separation position to the contact position when a number of rotations of the process motor M2 has reached a particular number of rotations required to rotate the photosensitive drum 50 by at least one full revolution. As a result, the photosensitive drum 50 can be charged at the particular number of rotations without depending on a torque of the photosensitive drum 50, and an entire surface of the photosensitive drum 50 can be uniformly and reliably charged without omission. The particular number of rotations of the process motor M2 for rotating the photosensitive drum 50 by at least one full revolution may be stored in advance in the NVRAM 94 based on a gear ratio of the drum driving gear train GT5 and the like.

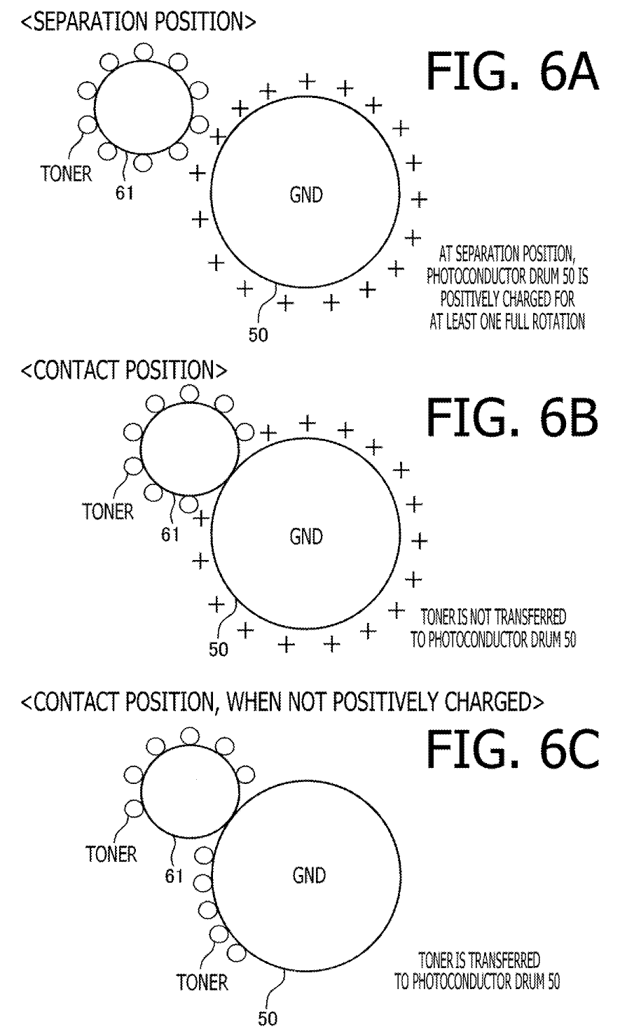

Accordingly, as shown in FIGS. 6A-6C, when the developing roller 61 is moved from the separation position to the contact position, positively charged toner that has moved to the surface of the developing roller 61 does not move from the developing roller 61 to the photosensitive drum 50, and the positively charged toner does not move to the surface of the photosensitive drum 50 due to the potential difference. On the other hand, if the entire surface of the photosensitive drum 50 is not uniformly positively charged, the toner unintentionally moves to the photosensitive drum 50 and the toner is wastefully consumed.

Further, the high-voltage power supply board 51 may apply a developing voltage to the developing roller 61 in addition to applying the voltage to the charger 52. In a case where the developing roller 61 is located at the separation position, the high-voltage power supply board 51 applies different positive voltages to the developing roller 61 and the charger 52 while applying a second positive voltage to the charger 52. The voltages are set such that a potential of the surface of the photosensitive drum 50 becomes higher than a potential of the developing roller 61.

Accordingly, when the developing roller 61 is moved from the separation position to the contact position, positively charged toner that has similarly moved to the surface of the developing roller 61 does not move from the developing roller 61 to the photosensitive drum 50. Therefore, the positively charged toner does not move to the surface of the photosensitive drum 50 due to the potential difference.

Further, the high-voltage power supply board 51 may apply a third negative voltage, and, at the separation position, the high-voltage power supply board 51 applies the third negative voltage to the charger 52. In addition, by rotating the process motor M2, the ASIC 92 rotates the photosensitive drum 50 and the driving roller 71 via the drum driving gear train GT5. The charger 52 negatively charges a surface of the photosensitive drum 50 based on the third negative voltage applied from the high-voltage power supply board 51. As the photosensitive drum 50 rotates, the entire surface of the photosensitive drum 50 is uniformly negatively charged. Here, the toner accommodated in the developing cartridge 60 is negatively charged toner that is charged with a negative polarity, and a potential of the surface of the photosensitive drum 50 is made lower than a potential of the developing roller 61.

Accordingly, when the developing roller 61 is moved from the separation position to the contact position, negatively charged toner that has moved to the surface of the developing roller 61 does not move from the developing roller 61 to the photosensitive drum 50, and the negatively charged toner does not move to the surface of the photosensitive drum 50 due to the potential difference.

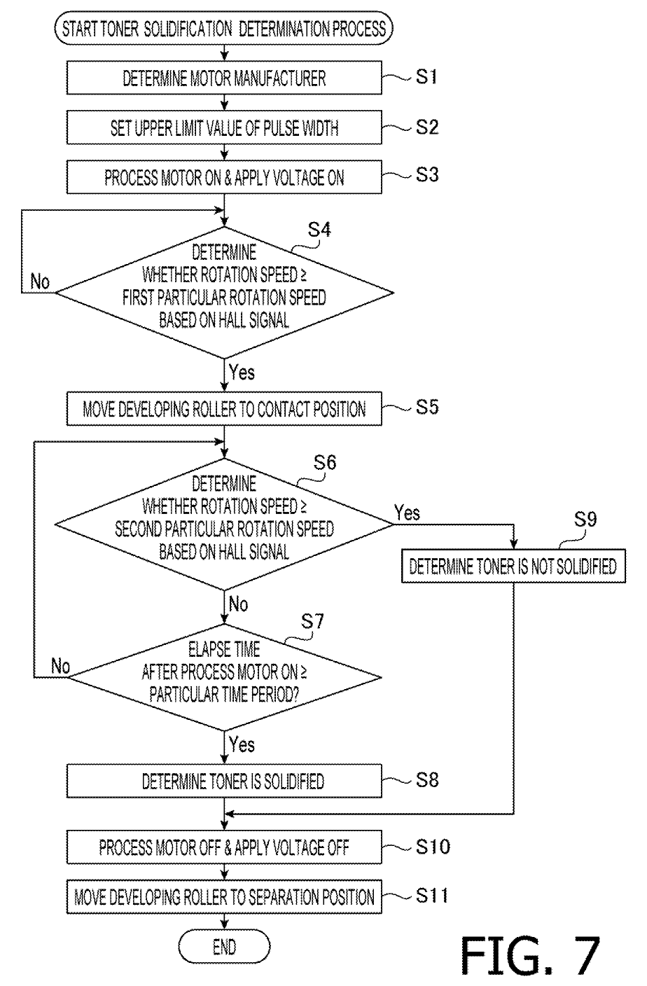

Next, the toner solidification determination process will be described with reference to FIG. 7. First, each step will hereinafter be denoted by “S”. In S1, the ASIC 92 determines a manufacturer of the process motor M2. Specifically, based on an FG signal and Hall signals that are input to the ASIC 92 via the process motor driving circuit 102 from the Hall elements M2U, M2V, and M2W and the FG sensor M2S, the ASIC 92 determines the manufacturer of the process motor M2 from characteristics of the signals. The manufacturer may alternatively be determined by reading a determination terminal provided in the process motor M2.

In S2, the ASIC 92 sets an upper limit value of a pulse width of the process motor M2. The upper limit values of the pulse width, which are determined in advance for the respective manufacturers, are stored in advance in the NVRAM 94. Based on the manufacturer of the process motor M2 determined in S1, the ASIC 92 sets the upper limit value of the pulse width stored in the NVRAM 94 as the upper limit value of the pulse width of the process motor M2.

The upper limit value of the pulse width is an upper limit value at which, when the ASIC 92 outputs the control signal so that an amount of current supplied to three-phase drive coils of the process motor M2 increases, the developing driving gear train GT6 serving as the drive transmission mechanism is not damaged by the rotation of the process motor M2.

In S3, the ASIC 92 drives the process motor M2. The high-voltage power supply board 51 applies a voltage to the charger 52, and the charger 52 positively charges a surface of the photosensitive drum 50 based on the positive voltage applied from the high-voltage power supply board 51. As described with reference to FIG. 5, the developing roller 61 is at the separation position.

In S4, the ASIC 92 determines whether the number of rotations of the process motor M2 has reached a first particular number of rotations required to rotate the photosensitive drum 50 by at least one full revolution. The ASIC 92 repeatedly makes the determination until the number of rotations of the process motor M2 reaches the first particular number of rotations required to rotate the photosensitive drum 50 by at least one full revolution, and, when the number of rotations has reached the first particular number of rotations or more, the ASIC 92 proceeds to S5. As described above, the photosensitive drum 50 is charged at the particular number of rotations, and an entire surface of the photosensitive drum 50 is uniformly and reliably charged without omission.

In S5, the ASIC 92 moves the developing roller 61 from the separation position to the contact position. Specifically, the ASIC 92 starts driving the main motor M1. Thereafter, by energizing the electromagnetic clutches EC1 and EC2, the ASIC 92 switches states of the clutches from the cutoff state to the transmission state and transmits the driving force of the main motor M1 to the developing separation gear train GT1. As a result, by the driving force of the main motor M1, the contact-and-separate mechanism 5 moves the developing roller 61 from the separation position to the contact position. Along with the movement to the contact position, the developing driving gear train GT6, which is the drive transmission mechanism, moves the movable gear 424 from the first disengaged position to the first transmission position. The switching lever 160 also stops rotation of an internal gear of the planetary gear mechanism 180. When a particular period of time elapses, the ASIC 92 stops energizing of the electromagnetic clutches EC1 and EC2 to switch states from the transmission state to the cutoff state and stops driving of the main motor M1.

In S6, the ASIC 92 drives the process motor M2 and measures the number of rotations of the process motor M2 based on Hall signals input from the Hall elements M2U, M2V, and M2W. The ASIC 92 further determines whether the process motor M2 has performed a rotation equal to or greater than a second particular number of rotations. When the process motor M2 has not rotated by the second particular number of rotations or more, the ASIC 92 proceeds to S7, and when the process motor M2 has rotated by the second particular number of rotations or more, the ASIC 92 proceeds to S9.

In S7, the ASIC 92 determines whether an elapsed time from a start of driving of the process motor M2 has reached a first particular time. Here, the first particular time is a time required for the process motor M2 to perform the second particular number of rotations when toner in the developing cartridge 60 is not solidified, and is a time that is insufficient for the process motor M2 to perform the second particular number of rotations when toner in the developing cartridge 60 is solidified. For example, the first particular time and the second particular number of rotations may be different for each manufacturer of the process motor M2 as determined in S1. When the elapsed time from the start of driving of the process motor M2 has reached the first particular time, the ASIC 92 proceeds to S8, and when the elapsed time from the start of driving of the process motor M2 has not reached the first particular time, the ASIC 92 proceeds to S6.

In S8, the ASIC 92 determines that the toner in the developing cartridge 60 has solidified. That is, the ASIC 92 determines that, due to toner solidification in the developing cartridge 60, the process motor M2 cannot perform the second particular number of rotations within the first particular time.

In S9, the ASIC 92 determines that toner in the developing cartridge 60 has not solidified.

In S10, the ASIC 92 stops driving of the process motor M2. The high-voltage power supply board 51 also stops application of the voltage to the charger 52.

In S11, the ASIC 92 moves the developing roller 61 from the contact position to the separation position. Specifically, the ASIC 92 starts driving the main motor M1. Thereafter, by energizing the electromagnetic clutches EC1 and EC2, the ASIC 92 switches the states from the cutoff state to the transmission state and transmits the driving force of the main motor M1 to the developing separation gear train GT1. As a result, by the driving force of the main motor M1, the contact-and-separate mechanism 5 moves the developing roller 61 from the contact position to the separation position. Along with the movement to the separation position, the developing driving gear train GT6, which is the drive transmission mechanism, moves the movable gear 424 from the first transmission position to the first disengaged position. The switching lever 160 also moves to a position where it does not stop rotation of the internal gear of the planetary gear mechanism 180. When a particular period of time elapses, the ASIC 92 stops energizing the electromagnetic clutches EC1 and EC2 to switch the states from the transmission state to the cutoff state and stops driving of the main motor M1.

Next, a determination of a motor failure will be described with reference to FIG. 7. First, in S21, the ASIC 92 switches the electromagnetic clutches EC1 and EC2 from the transmission state to the cutoff state by stopping energizing of the electromagnetic clutches EC1 and EC2, and stops driving of the main motor M1. When the developing roller 61 is at the contact position, the ASIC 92 moves the developing roller 61 from the contact position to the separation position as described above, and then stops energizing of the electromagnetic clutches EC1 and EC2 and stops driving of the main motor M1.

In S22, the ASIC 92 drives the process motor M2. Here, since the developing roller 61 is at the separation position, the driving force from the process motor M2 is not transmitted to the developing rollers 61 (i.e., 61Y, 61M, 61C, 61K).

In S23, the ASIC 92 determines whether a rotational speed of the process motor M2 has reached a target speed within the second particular time. When the rotational speed has reached the target speed within the second particular time, the ASIC 92 proceeds to S24, and when the rotational speed has not reached the target speed within the second particular time, the ASIC 92 proceeds to S25.

In S24, the ASIC 92 determines that the process motor M2 is normal. The process motor M2 is a three-phase brushless motor, and feedback control is executed by the ASIC 92 based on an FG signal output from the FG sensor M2S. Specifically, the process motor M2 is controlled such that a PWM signal, which is a control signal indicating a pulse width (duty ratio), is changed by the feedback control so as to reach a target rotational speed. Therefore, when the target rotational speed is reached, the process motor M2 is determined to be operating normally.

In S25, the ASIC 92 determines that the process motor M2 has failed. Similarly to the above, when the rotational speed does not reach the target rotational speed, the process motor M2 is determined to be in failure.

Next, usage ways of the toner solidification determination process and the motor failure determination described above will be explained. It goes without saying that the toner solidification determination and the motor failure determination can each be performed at any timing and are not limited to the descriptions below.

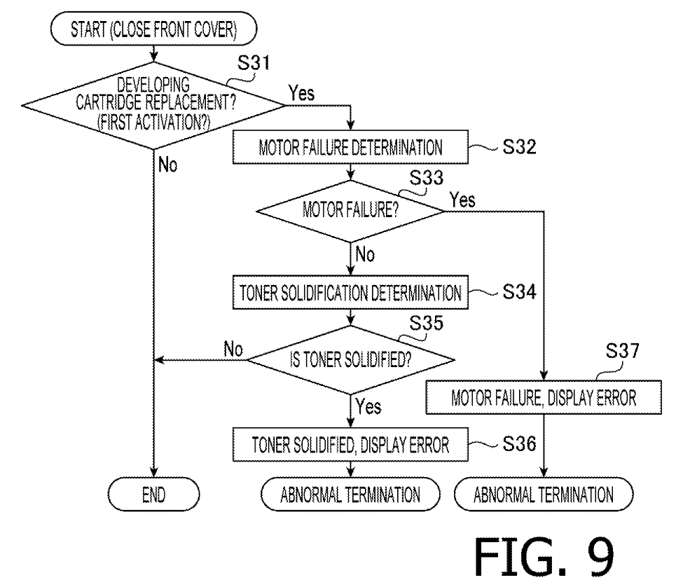

First, FIG. 9 is a flowchart illustrating control of the image forming apparatus 1 at the time of a developing cartridge replacement, and this control is executed when the front cover 11 at the front portion of the housing 10 is opened and closed. First, in S31, the ASIC 92 determines whether the developing cartridge replacement, has been performed. In other words, the ASIC 92 determines whether the developing cartridge 60 has been replaced. Specifically, the ASIC 92 monitors whether identification information has changed by reading toner ICs 62 provided in the respective developing cartridges 60. When the developing cartridge 60 has been mounted, the procedure proceeds to S32, and when a developing cartridge 60 has not been replaced, this control is terminated. Note that matters described in parentheses will be described later.

In S32, the ASIC 92 executes the motor failure determination. Since the motor failure determination is the same as that already described above, detailed description is omitted. In S33, when the process motor M2 has been determined to have failed by the failure determination in S32, the procedure proceeds to S37, and when the process motor M2 has been determined to be normal, the procedure proceeds to S34.

In S34, the ASIC 92 executes the toner solidification determination process. Since the toner solidification determination is the same as that already described above, detailed description is omitted. In S35, when it is determined by the toner solidification determination process executed in S34 that toner inside the developing cartridge 60 has solidified, the procedure proceeds to S36, and when it is determined that toner inside the developing cartridge 60 has not solidified, this control process is terminated.

Accordingly, the toner solidification determination process is executed after execution of the motor failure determination process, only when the process motor M2 has not been determined to be in failure. Thus, it is possible to prevent toner solidification from being erroneously detected by the toner solidification determination process due to the fact that the number of rotations of the process motor M2 does not reach the second particular number of rotations because the process motor M2 is in failure.

In S36, the display 14 displays an error image informing a user of the toner solidification. In this way, the user is notified of toner solidification and is prompted to perform a developing cartridge replacement or the like. In S37, the display 14 displays an error image informing a user of the motor failure. In this way, the user is notified of the motor failure and is prompted to perform maintenance or the like.

Here, in S31, the ASIC 92 may determine whether the image forming apparatus 1 is new. Specifically, in response to activation of power of the image forming apparatus 1, the ASIC 92 determines whether the activation is a first activation of the image forming apparatus 1. Subsequent processing is the same as that in FIG. 9. As a method of determining whether the activation is the first activation of the image forming apparatus 1, a configuration may be adopted in which the apparatus is shipped with a startup history in the NVRAM 94 being empty at the time of shipping, and the startup history is stored at subsequent activations. In this way, the ASIC 92 refers to the startup history stored in the NVRAM 94 and determines that the activation is the first activation of the image forming apparatus 1 when no startup history exists. Accordingly, it is possible to perform determination of toner solidification due to temperature changes during transportation and long-term storage before printing is performed.

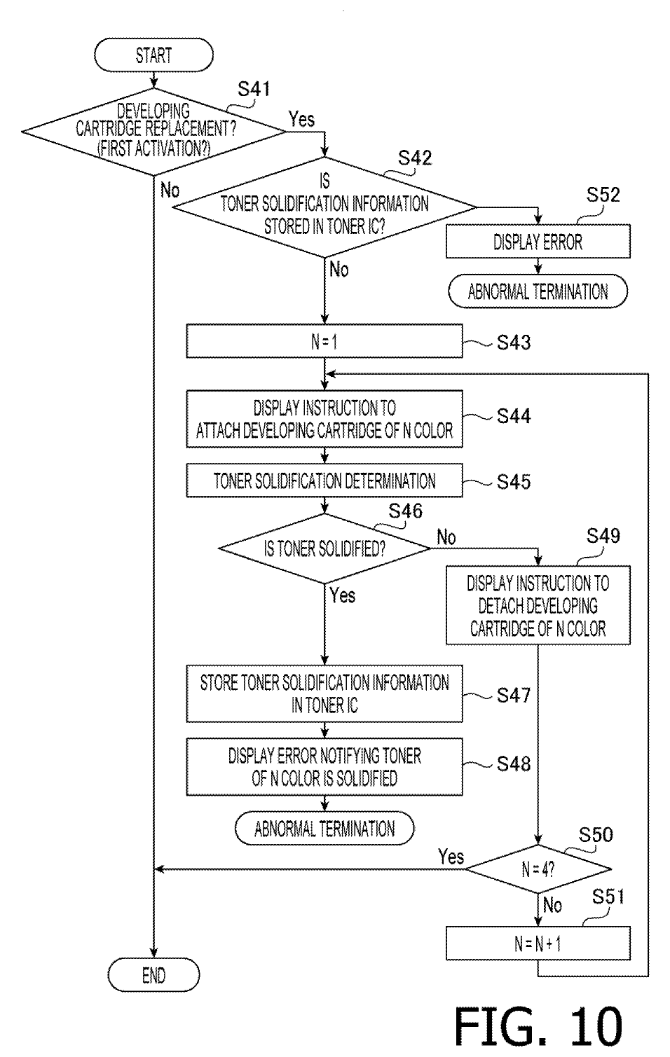

Second, FIG. 10 is a flowchart illustrating control of the image forming apparatus 1 in a mode for determining a color the toner has solidified. First, in S41, the ASIC 92 determines, similarly to the flowchart in FIG. 9, whether the developing cartridge 60 has been replaced or this is the first activation of the image forming apparatus 1. If the determination is affirmative, the procedure advances to S42, and if the determination is negative, this control is terminated.

In S42, the ASIC 92 determines whether toner solidification information is stored in the toner IC 62 included in the developing cartridge 60. The toner solidification information is a history of toner solidification that is stored in the toner IC 62, which serves as a storage, when toner is determined to have solidified by a toner solidification determination process. When it is determined that the solidification information is stored, the procedure proceeds to S52, and when it is determined that the solidification information is not stored, the procedure proceeds to S43.

In S43, the ASIC 92 sets a value of a variable N to 1. The variable N is set to an integer from 1 to 4. In S43, although not shown in this flowchart, the motor failure determination may also be executed. In S44, the display 14 displays an instruction to mount only the developing cartridge 60 corresponding to the value of the variable N. Accordingly, the user attaches and detaches the developing cartridges 60 so that only the instructed developing cartridge 60 is mounted. In this case, N=1 corresponds to the developing cartridge 60Y, N=2 corresponds to the developing cartridge 60M, N=3 corresponds to the developing cartridge 60C, and N=4 corresponds to the developing cartridge 60K.

In S45, the ASIC 92 executes the toner solidification determination process. Specifically, the toner solidification determination process is executed in a state where one developing cartridge among four developing cartridges is mounted, and the presence or absence of toner solidification is determined for the one developing cartridge. In S46, when it is determined, by the toner solidification determination process of S45, that toner inside the developing cartridge 60 has solidified, the procedure proceeds to S47, and when it is determined that toner inside the developing cartridge 60 has not solidified, the procedure proceeds to S49.

In S47, the ASIC 92 executes a toner solidification information storage process in which toner solidification information is stored in the toner IC 62 of the developing cartridge 60 that has been determined, by the toner solidification determination process of S45, to contain solidified toner. As a result, individual toner solidification information is stored in the toner IC 62 of the developing cartridge 60. In S48, the display 14 displays an error image informing the user of the developing cartridge 60 in which toner has solidified.

In S49, the display 14 displays an image prompting removal of the developing cartridge 60 that has been determined, by the toner solidification determination process of S45, not to contain solidified toner.

In S50, the ASIC 92 determines whether the value of the variable N is 4. When the determination is negative, the procedure proceeds to S51. When the determination in S50 is affirmative, that is, when N=4, this indicates a case where the toner solidification determination process has been individually executed for all four developing cartridges 60 (i.e., 60Y, 60M, 60C, 60K) and the toner solidification has not been determined for the four developing cartridges 60. In S51, the ASIC 92 increments the value of the variable N by 1. Thereafter, the procedure proceeds to S44, and the display 14 displays an instruction to mount a developing cartridge different from a developing cartridge for which the toner solidification determination process has already been executed. Accordingly, the ASIC 92 can sequentially execute the toner solidification determination process in a state where one developing cartridge is mounted.

In S52, the display 14 displays that the developing cartridge 60 in which the toner solidification information is stored has been mounted. That is, when it is determined in S42 that toner solidification information has been stored in the toner IC 62 provided in the developing cartridge 60, the ASIC 92 does not execute the toner solidification determination process.

According to the above, by executing the toner solidification determination process in a state where one developing cartridge 60 is mounted, when toner solidification is determined, it is possible to specify the developing cartridge 60 in which toner has solidified. Furthermore, by storing and determining the toner solidification information, unintended duplicate toner solidification determination processes can be prevented.

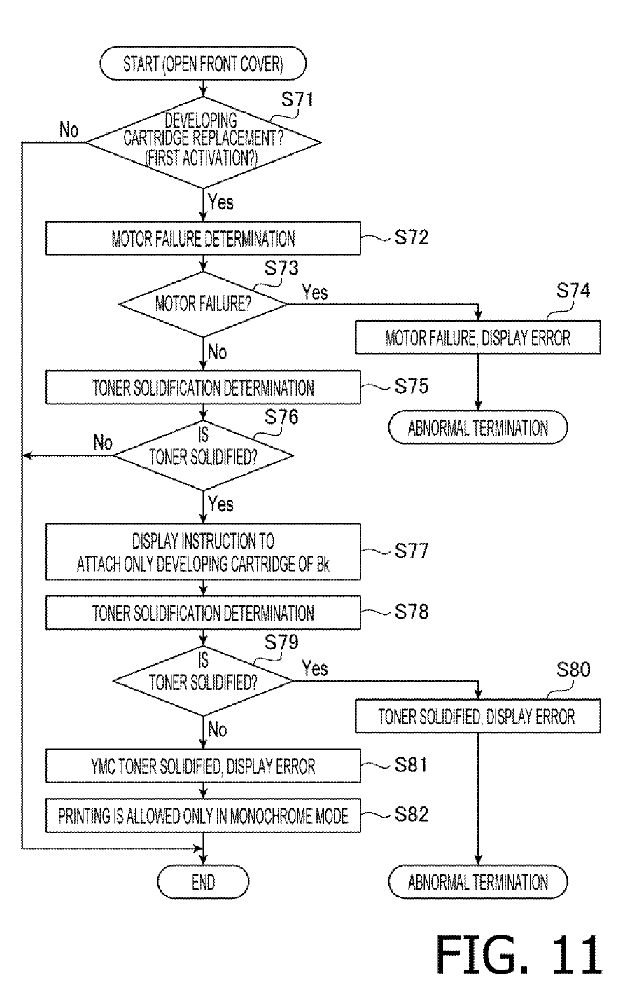

Third, FIG. 11 is a flowchart illustrating control of the image forming apparatus 1 in a mode for determining whether monochrome printing is possible. Here, S71 to S76 are the same as S31 to S35 and S37 in FIG. 9, and therefore description thereof is omitted.

In S77, the display 14 displays an instruction to mount only the developing cartridge 60K that accommodates black toner. In S78, the ASIC 92 executes the toner solidification determination process with only the developing cartridge 60K mounted. That is, when, in S76, the toner solidification determination process has been executed in a state where all of the developing cartridges 60 (i.e., 60Y, 60M, 60C, 60K) are mounted and toner solidification has been determined, the ASIC 92 determines whether the toner solidification is caused by the developing cartridge 60K.

In S79, when it is determined, by the toner solidification determination executed in the toner solidification determination process of S78, that toner inside the developing cartridge 60K has solidified, the procedure proceeds to S80, and when it is determined that toner inside the developing cartridge 60K has not solidified, the procedure proceeds to S81.

In S80, the display 14 displays an error indication that printing is impossible and an error image informing the user of toner solidification. In this way, the user is notified of the toner solidification and is prompted to perform a developing cartridge replacement or the like. It is also possible to display at least that toner has solidified in the developing cartridge 60K that accommodates black toner.

In S81, the display 14 displays an error image informing the user of toner solidification. It is also possible to display at least that toner has solidified in one or more of the developing cartridge 60Y, the developing cartridge 60M, and the developing cartridge 60C.

In S82, the ASIC 92 enables only monochrome printing using black toner. Specifically, the electromagnetic clutch EC1 is set so that it cannot be switched from a cutoff state to a transmission state, and an electromagnetic clutch EC2 is set so that it can be switched from the cutoff state to the transmission state. As a result, the developing cartridge 60Y, the developing cartridge 60M, and the developing cartridge 60C are located at the separation position and are set so as not to receive transmission of a driving force from the process motor M2. In addition, the display 14 displays an image informing the user that monochrome printing is possible.

As described in detail above, according to the image forming apparatus 1 of the present embodiment, the ASIC 92, in a state where the developing roller 61 is at the separation position, rotates the photosensitive drum 50 by using the process motor M2 while applying a voltage to the charger 52 by using the high-voltage power supply board 51 (S3), and thereafter, in a state where the developing roller 61 has been moved from the separation position to the contact position by using the contact-and-separate mechanism 5 (S5), executes the toner solidification determination process (S6, S7, S8, and S9) that determines whether toner solidification has occurred in a toner storage based on a rotation of the process motor M2.

Accordingly, since a potential difference is generated in advance between the photosensitive drum 50 and the developing roller 61 while the photosensitive drum 50 and the developing roller 61 are in the separated state, even when the photosensitive drum 50 and the developing roller 61 come into a contact state, the toner is prevented from flowing from the developing roller 61 toward the photosensitive drum 50.

Further, when applying a voltage to the charger 52 by using the high-voltage power supply board 51 in a state where the developing roller 61 is at the separation position (S3), after the number of rotations of the process motor M2 has reached the first particular number of rotations corresponding to at least one full revolution of the photosensitive drum 50 (S4), the ASIC 92 moves the developing roller 61 from the separation position to the contact position by using the contact-and-separate mechanism 5 (S5). Accordingly, since a potential difference between the photosensitive drum 50 and the developing roller 61 can be generated over an entire surface of the photosensitive drum 50, any opportunity for toner to flow from the developing roller 61 toward the photosensitive drum 50 can be eliminated.

Furthermore, when determining toner solidification based on a rotation of the process motor M2 in a state where the developing roller 61 has been moved from the separation position to the contact position by using the contact-and-separate mechanism 5, the ASIC 92 determines that toner solidification has not occurred (S9) when the number of rotations of the process motor M2 has reached a second particular number of rotations or more within the first particular time (S6: YES), and determines that toner solidification has occurred (S8) when the number of rotations of the process motor M2 does not reach the second particular number of rotations within the first particular time (S7: YES). Accordingly, toner solidification can be determined by monitoring the number of rotations of the process motor M2.

Moreover, the ASIC 92 determines a manufacturer of the process motor M2 based on a signal from the process motor M2 (S1). When executing feedback control that changes a pulse width of the control signal output to the motor driving circuit 102 in accordance with a rotational speed of the process motor M2, the ASIC 92 sets an upper limit value of the pulse width of the control signal to an upper limit value for the manufacturer that is stored in the NVRAM 94 (S2).

Accordingly, since the upper limit value of the pulse width of the control signal is set in accordance with a value corresponding to each manufacturer of the process motor M2, the process motor M2 is prevented from being excessively rotated, and damage to the developing driving gear train GT6 can be prevented.

Further, the ASIC 92 executes the toner solidification determination process (S35, S46, S76, and S79) when it is the first activation of the image forming apparatus 1 (S31, S41, S71) or when attachment of the developing cartridge 60 is detected (S31, S41, S71).

Accordingly, even when toner inside the image forming apparatus 1 or the developing cartridge 60 has solidified due to effects of temperature changes during transportation or long‑term storage, the toner solidification determination can be performed before printing is carried out.

Additionally, the ASIC 92 executes the toner solidification determination process in a state where one developing cartridge 60 among the plurality of developing cartridges 60 is mounted, and determines whether the toner solidification has occurred for the one developing cartridge (S46, S79).

Accordingly, since the ASIC 92 determines toner solidification for one developing cartridge 60, it is possible to determine whether toner has solidified in the relevant developing cartridge 60. When the ASIC 92 executes the toner solidification determination process (S46) in a state where one developing cartridge 60 among the plurality of developing cartridges 60 is mounted and determines that toner solidification has not occurred (S46: NO), the ASIC 92 causes the display 14 to display an instruction to remove the one developing cartridge 60 (S49) and an instruction to mount the developing cartridge 60 that is different from the one developing cartridge 60 (S51, S44).

Accordingly, the ASIC 92 can sequentially determine toner solidification for each developing cartridge 60, and can determine the toner solidification for respective toners.

Further, when, as a result of executing the toner solidification determination process (S46) in a state where one developing cartridge 60 is mounted, the ASIC 92 determines that toner solidification has occurred (S46: YES), the ASIC 92 executes the toner solidification information storage process (S47) to store the toner solidification information in the toner IC 62 of the one developing cartridge 60.

Accordingly, by storing the toner solidification information in the toner IC 62, the ASIC 92 can store information indicating the fact that toner has been determined to have solidified in that developing cartridge 60.

Further, after the toner solidification information storage process (S47), when a new developing cartridge 60 has been mounted (S41), if the toner solidification information is not stored in the toner IC 62 of the newly mounted developing cartridge 60 (S42: NO), the ASIC 92 executes the toner solidification determination process (S46), and if the toner solidification information is stored in the toner IC 62 of the mounted developing cartridge 60 (S42: YES), the ASIC 92 does not execute the toner solidification determination process.

Accordingly, by determining whether toner solidification information is stored in the toner IC 62, the ASIC 92 can eliminate unintended duplicate toner solidification determination processes.

Further, when, as a result of execution of the toner solidification determination process, it is determined that toner solidification has occurred (S47: YES), the ASIC 92 causes the display 14 to display an instruction to mount only the developing cartridge 60K that contains black toner (S77). Thereafter, as a result of executing the toner solidification determination process (S78) in a state where only the developing cartridge 60K that contains black toner is mounted, if the toner solidification is not determined (S79: NO), the ASIC 92 causes the display 14 to display information indicating that monochrome printing is possible (S82), and if the toner solidification is determined (S79: YES), the ASIC 92 causes the display 14 to display an error indication that printing is impossible (S80).

Accordingly, even when toner has solidified in the developing cartridge 60 other than the developing cartridge 60K that contains black toner, monochrome printing can be performed by using the developing cartridge 60 that contains the black toner.

Furthermore, the ASIC 92 rotates the process motor M2 in a state where the developing roller 61 is at the separation position (S22), determines whether a rotational speed of the process motor M2 has reached the target speed within the second particular time (S23), and executes the failure determination process (S25) in which the process motor M2 is determined to have failed when the target speed has not been reached within the second particular time (S23: NO). The toner solidification determination processes (S35, S46, S76) are executed after execution of the failure determination processes (S33, S43, S73), and only when the process motor M2 has not been determined to have failed.

Accordingly, since the ASIC 92 performs the toner solidification determination after determining that the process motor M2 is not in failure, it is possible to prevent toner from being erroneously detected as having solidified due to a failure of the process motor M2.

It should be understood that the present application is not limited to the above embodiment, and that various modifications and alterations can of course be made without departing from the spirit of the present application. For example, although the above embodiment has been described with reference to a laser printer, the present invention may be applied to a multifunction peripheral having the same configuration, or to a household or industrial printer.

In the above embodiment, the toner IC 62, which is an example of a storage of the developing cartridge 60, has been described as storing, as toner solidification information, a history of solidification. However, the toner IC 62, which is an example of the storage, may store, as the toner solidification information, an identification number for referencing a history of toner solidification. In this case, the history of toner solidification may be stored in the NVRAM 94, and the history of toner solidification may be read out from the NVRAM 94 in accordance with the identification number.

What is claimed is:

1. An image forming apparatus comprising:
a photosensitive drum;
a charger configured to charge the photosensitive drum;
a developing cartridge including a toner storage configured to accommodate toner, and a developing roller configured to supply the toner to the photosensitive drum;
a contact‑and‑separate mechanism configured to move the developing roller between a contact position and a separation position, the contact position being a position where the developing roller is in contact with the photosensitive drum, the separation position being a position where the developing roller is separated from the photosensitive drum;
a process motor configured to rotate the photosensitive drum and the developing roller;
a drive transmission mechanism configured to transmit a driving force from the process motor to the developing roller when the developing roller is at the contact position, and not to transmit the driving force from the process motor to the developing roller when the developing roller is at the separation position;
a high-voltage power supply board configured to apply, to the charger, a voltage for charging the photosensitive drum; and
a controller,
wherein the controller is configured to execute a toner solidification determination process of applying the voltage to the charger by using the high‑voltage power supply board while rotating the photosensitive drum by using the process motor in a state where the developing roller is at the separation position, and thereafter, determining whether toner solidification has occurred in the toner storage based on a rotation of the process motor in a state where the developing roller has been moved from the separation position to the contact position by using the contact‑and‑separate mechanism.

2. The image forming apparatus according to claim 1,
wherein, when the voltage is applied to the charger by using the high-voltage power supply board in a state where the developing roller is at the separation position, the controller is configured to move the developing roller from the separation position to the contact position by using the contact‑and‑separate mechanism after a number of rotations of the process motor has reached a first particular number of rotations corresponding to at least one full revolution of the photosensitive drum.

3. The image forming apparatus according to claim 1,
wherein, when executing the toner solidification determination process based on a rotation of the process motor in a state where the developing roller has been moved from the separation position to the contact position by using the contact‑and‑separate mechanism, the controller is configured not to determine that the toner solidification has occurred when a number of rotations of the process motor has reached a second particular number of rotations or more within a first particular time, and to determine that the toner solidification has occurred when the number of rotations of the process motor does not reach the second particular number of rotations within the first particular time.

4. The image forming apparatus according to claim 1,
wherein the process motor is a three‑phase brushless motor including three‑phase drive coils, a Hall element configured to detect a rotational position of a rotor, and an FG sensor in which an induced electromotive force is generated in accordance with rotation of the rotor;
wherein the image forming apparatus further comprises a motor driving circuit configured to, in response to a control signal input from the controller, control an amount of current supplied to the three‑phase drive coils and switch timing of supplying current to the three‑phase drive coils; and
wherein, when rotating the process motor, the controller is configured to:
detect a number of rotations of the process motor based on a Hall signal input from the Hall element via the motor driving circuit;
detect a rotational speed of the process motor based on an FG signal input from the FG sensor via the motor driving circuit; and
perform feedback control that changes a pulse width of the control signal output to the motor driving circuit in accordance with the rotational speed.

5. The image forming apparatus according to claim 4, further comprising a non‑volatile memory configured to store an upper limit value of the pulse width of the control signal for each manufacturer of the process motor, in such a manner that the drive transmission mechanism is not damaged by rotation of the process motor due to an increase in an amount of current supplied to the three‑phase drive coils of the process motor,
wherein the controller is configured to:
determine a manufacturer of the process motor based on a signal output from the process motor; and
when executing the feedback control that changes the pulse width of the control signal output to the motor driving circuit in accordance with the rotational speed, set an upper limit value of the pulse width of the control signal to the upper limit value for the manufacturer stored in the non‑volatile memory.

6. The image forming apparatus according to claim 1, further comprising:
a fixing device that thermally fixes a toner image formed on a sheet by the photosensitive drum, the fixing device including a heating rotor having a heater and a pressing rotor configured to press the sheet between the pressing rotor and the heating rotor; and
a main motor configured to rotate the heating rotor and the pressing rotor of the fixing device,
wherein the contact‑and‑separate mechanism is configured to move the developing roller between the contact position and the separation position by a driving force from the main motor.

7. The image forming apparatus according to claim 1,
wherein the toner is positively charged toner charged with a positive polarity, and
wherein, in a case where the voltage is applied to the charger by using the high‑voltage power supply board in a state where the developing roller is at the separation position, the controller is configured to make a potential of the photosensitive drum higher than a potential of the developing roller by applying, to the charger, a first positive voltage by using the high‑voltage power supply board.

8. The image forming apparatus according to claim 1,
wherein the toner is positively charged toner charged with a positive polarity, and
wherein, in a case where the voltage is applied to the charger by using the high‑voltage power supply board in a state where the developing roller is at the separation position, the controller is configured to apply, to the charger, a second positive voltage by using the high‑voltage power supply board and to apply a positive developing voltage to the developing roller, thereby bringing the photosensitive drum into a state where a potential of the photosensitive drum is higher than a potential of the developing roller by a voltage difference between the second positive voltage and the positive developing voltage.

9. The image forming apparatus according to claim 1,
wherein the toner is negatively charged toner charged with a negative polarity, and
wherein, in a case where the voltage is applied to the charger by using the high‑voltage power supply board in a state where the developing roller is at the separation position, the controller is configured to apply, to the charger, a third negative voltage by using the high‑voltage power supply board, thereby bringing the photosensitive drum into a state where a potential of the photosensitive drum is lower than a potential of the developing roller.

10. The image forming apparatus according to claim 1, further comprising a cover,
wherein the developing cartridge is attachable to and detachable from the image forming apparatus when the cover is open, and
wherein the controller is configured to execute the toner solidification determination process when a first activation of the image forming apparatus is performed or when replacement of the developing cartridge is detected.

11. The image forming apparatus according to claim 10,
wherein the photosensitive drum includes a plurality of photosensitive drums,
wherein the developing cartridge includes a plurality of developing cartridges arranged corresponding to the plurality of photosensitive drums, respectively, and
wherein the controller is configured to execute the toner solidification determination process in a state where one developing cartridge among the plurality of developing cartridges is mounted to determine whether the toner solidification has occurred for the one developing cartridge.

12. The image forming apparatus according to claim 11, further comprising a display,
wherein, when the toner solidification determination process has been executed in a state where one developing cartridge among the plurality of developing cartridges is mounted and when the controller determines that the toner solidification has not occurred, the controller causes the display to display an instruction to remove the one developing cartridge and an instruction to mount a developing cartridge that is different from the one developing cartridge.

13. The image forming apparatus according to claim 11,
wherein each of the plurality of developing cartridges has a storage, and
wherein when the controller determines that the toner solidification has occurred as a result of execution of the toner solidification determination process in a state where the one developing cartridge is mounted, the controller is configured to execute a toner solidification information storage process of storing toner solidification information in the storage of the one developing cartridge.

14. The image forming apparatus according to claim 13,
wherein, after the toner solidification information storage process, in a case where a developing cartridge has been newly mounted, the controller is configured to execute the toner solidification determination process when toner solidification information is not stored in the storage of the newly mounted developing cartridge, and not to execute the toner solidification determination process when the toner solidification information is stored in the storage of the newly mounted developing cartridge.

15. The image forming apparatus according to claim 1, further comprising a cover and a display,
wherein the photosensitive drum includes a plurality of photosensitive drums,
wherein the developing cartridge includes a plurality of developing cartridges arranged corresponding to the plurality of photosensitive drums, respectively, and are attachable to and detachable from the image forming apparatus when the cover is open, and
wherein, as a result of execution of the toner solidification determination process in a state where all of the plurality of developing cartridges are mounted, when the controller determines that the toner solidification has occurred, the controller is configured to cause the display to display an instruction to mount only a developing cartridge that contains black toner, and
wherein as a result of execution of the toner solidification determination process in a state where only the developing cartridge that contains the black toner is mounted, when the controller determines that toner solidification has not occurred, the controller is configured to cause the display to display that monochrome printing is possible, and when the controller determines that toner solidification has occurred, the controller is configured to cause the display to display an error indicating that printing is impossible.

16. The image forming apparatus according to claim 1,
wherein the controller is configured to rotate the process motor in a state where the developing roller is at the separation position, to determine whether a rotational speed of the process motor has reached a target speed within a second particular time, and to execute a failure determination process of determining that the process motor has failed when the target speed has not been reached within the second particular time, and
wherein the controller is configured to execute the toner solidification determination process after execution of the failure determination process when the controller determines that the process motor has not failed.
